(19) United States
(12) Patent Application Publication
(10) Pub. No.: US 2012/0106640 A1
(43) Pub. Date: May 3, 2012

(54) Decoding side intra-prediction derivation for video coding

(75) Inventors: Ba-Zhong Shen, Irvine, CA (US); Brian Heng, Irvine, CA (US)

(73) Assignee: BROADCOM CORPORATION, IRVINE, CA (US)

(21) Appl. No.: 12/945,949

(22) Filed: Nov. 15, 2010

Related U.S. Application Data
(60) Provisional application No. 61/408,647, filed on Oct. 31, 2010.

(51) Int. Cl. H04N 7/12

(52) U.S. Cl. 375/240.16; 375/E07.243

(57) ABSTRACT

Decoding side intra-prediction derivation for video coding. Just decoded pixels within a given picture (image) (e.g., such as a given picture (image) within video data) are employed for decoding other pixels within that very same picture (image) using prediction vectors extending from the just decoded pixels to the pixels currently being decoded. In one instance, this intra-prediction operation in accordance with video or image processing can also operate using relatively limited information provided from the device that provides or transmits the video data to the device in which it undergoes processing. Coarse and/or refined direction information corresponding to these prediction vectors may be provided from the device that provides or transmits the video data to the device in which it undergoes processing.

### CROSS REFERENCE TO RELATED PATENTS/PATENT APPLICATIONS

### Provisional Priority Claims

The present U.S. Utility Patent Application claims priority pursuant to 35

U.S.C. §119(e) to the following U.S. Provisional Patent Application which is hereby incorporated herein by reference in its entirety and made part of the present U.S. Utility Patent Application for all purposes:

1. U.S. Provisional Application Ser. No. 61/408,647, entitled “Decoding side intra-prediction derivation for video coding,” (Attorney Docket No. BP22257), filed Oct. 31, 2010, pending.

### BACKGROUND OF THE INVENTION

1. Technical Field of the Invention

The invention relates generally to digital video processing; and, more particularly, it relates to performing decoding side intra-prediction derivation in accordance with such digital video processing.

2. Description of Related Art

Communication systems that operate to communicate digital media (e.g., images, video, data, etc.) have been under continual development for many years. With respect to such communication systems employing some form of video data, a number of digital images are output or displayed at some frame rate (e.g., frames per second) to effectuate a video signal suitable for output and consumption. Within many such communication systems operating using video data, there can be a trade-off between throughput (e.g., number of image frames that may be transmitted from a first location to a second location) and video or image quality of the signal eventually to be output or displayed. The present art does not adequately or acceptably provide a means by which video data may be transmitted from a first location to a second location in accordance with providing an adequate or acceptable video or image quality, ensuring a relatively low amount of overhead associated with the communications, etc.

### BRIEF SUMMARY OF THE INVENTION

The present invention is directed to apparatus and methods of operation that are further described in the following Brief Description of the Several Views of the Drawings, the Detailed Description of the Invention, and the claims. Other features and advantages of the present invention will become apparent from the following detailed description of the invention made with reference to the accompanying drawings.

### BRIEF DESCRIPTION OF THE SEVERAL VIEWS OF THE DRAWINGS

FIG. 1 and FIG. 2 illustrate various embodiments of communication systems.

FIG. 3A illustrates an embodiment of a computer.

FIG. 3B illustrates an embodiment of a laptop computer.

FIG. 3C illustrates an embodiment of a high definition (HD) television.

FIG. 3D illustrates an embodiment of a standard definition (SD) television.

FIG. 3E illustrates an embodiment of a handheld media unit.

FIG. 3F illustrates an embodiment of a set top box (STB).

FIG. 3G illustrates an embodiment of a digital video disc (DVD) player.

FIG. 3H illustrates an embodiment of a generic digital image processing device.

FIG. 4 illustrates an embodiment of a 4×4 and 8×8 luma intra-prediction directions.

FIG. 5 illustrates an embodiment of a plurality of possible operational modes for 4×4 luma intra-prediction.

FIG. 6 illustrates an embodiment of a decoder side intra-prediction derivation (DIPD) with respect to a digital image.

FIG. 7 illustrates an embodiment of a selective and different weighting of prediction vectors with respect to a digital image.

FIG. 8A illustrates an embodiment of partial decoder side intra-prediction derivation (DIPD) operating in accordance with decoder refinement.

FIG. 8B illustrates an embodiment of partial DIPD operating in accordance with encoder refinement.

FIG. 8C illustrates an embodiment of a total DIPD in which a decoder operates independently on received video data.

FIG. 9A, FIG. 9B, FIG. 10A, FIG. 10B, FIG. 11A, and FIG. 11B illustrate various embodiments of methods for operating video processing devices.

### DETAILED DESCRIPTION OF THE INVENTION

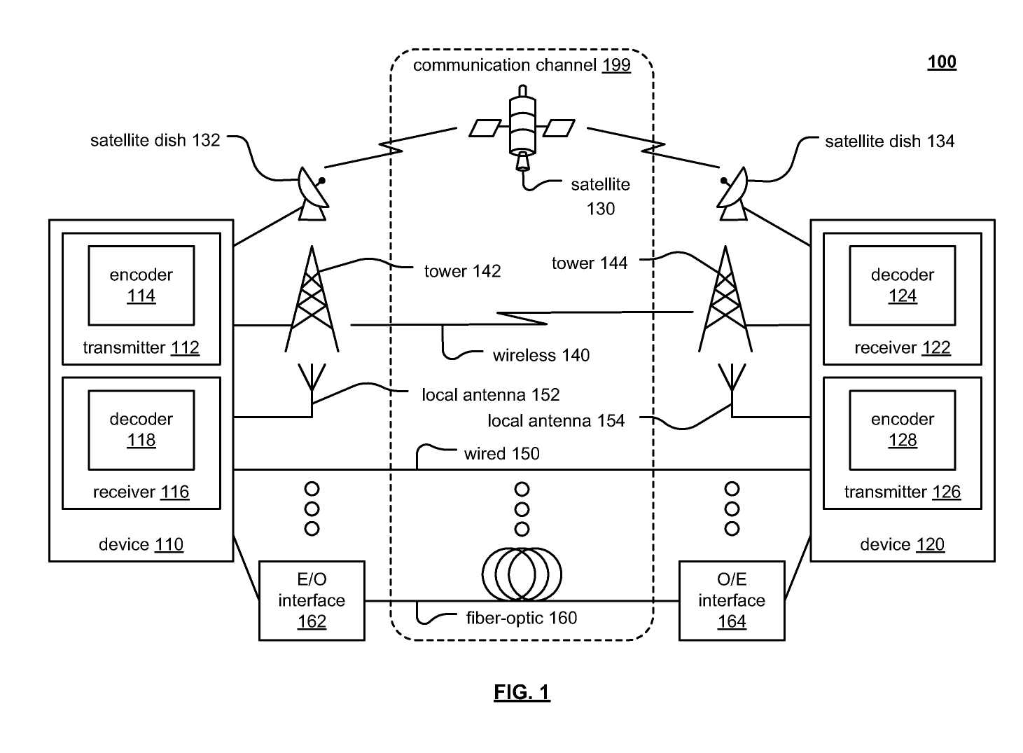

Within many devices that use digital media such as digital video, respective images thereof, being digital in nature, are represented using pixels. Within certain communication systems, digital media can be transmitted from a first location to a second location at which such media can be output or displayed. The goal of digital communications systems, including those that operate to communicate digital video, is to transmit digital data from one location, or subsystem, to another either error free or with an acceptably low error rate. As shown in FIG. 1, data may be transmitted over a variety of communications channels in a wide variety of communication systems: magnetic media, wired, wireless, fiber, copper, and other types of media as well.

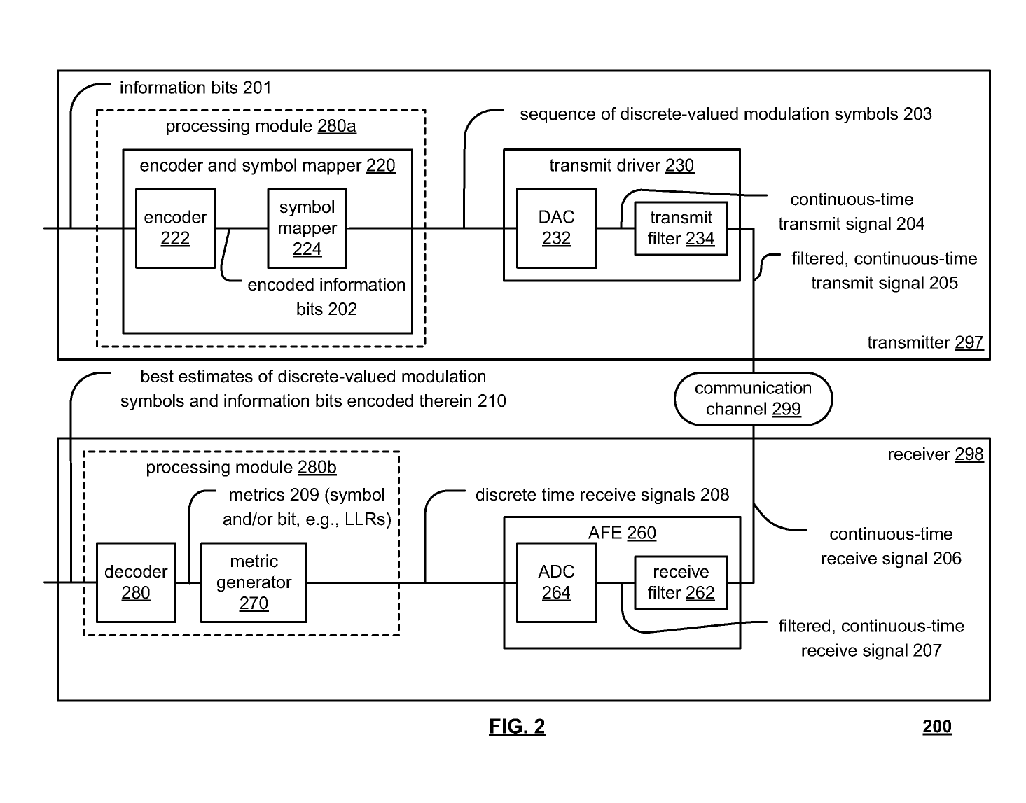

FIG. 1 and FIG. 2 are diagrams illustrate various embodiments of communication systems, 100 and 200, respectively.

Referring to FIG. 1, this embodiment of a communication system 100 is a communication channel 199 that communicatively couples a communication device 110 (including a transmitter 112 having an encoder 114 and including a receiver 116 having a decoder 118) situated at one end of the communication channel 199 to another communication device 120 (including a transmitter 126 having an encoder 128 and including a receiver 122 having a decoder 124) at the other end of the communication channel 199. In some embodiments, either of the communication devices 110 and 120 may only include a transmitter or a receiver. There are several different types of media by which the communication channel 199 may be implemented (e.g., a satellite communication channel 130 using satellite dishes 132 and 134, a wireless communication channel 140 using towers 142 and 144 and/or local antennae 152 and 154, a wired communication channel 150, and/or a fiber-optic communication channel 160 using electrical to optical (E/O) interface 162 and optical to electrical (O/E) interface 164)). In addition, more than one type of media may be implemented and interfaced together thereby forming the communication channel 199.

To reduce transmission errors that may undesirably be incurred within a communication system, error correction and channel coding schemes are often employed. Generally, these error correction and channel coding schemes involve the use of an encoder at the transmitter end of the communication channel 199 and a decoder at the receiver end of the communication channel 199.

Any of various types of ECC codes described can be employed within any such desired communication system (e.g., including those variations described with respect to FIG. 1), any information storage device (e.g., hard disk drives (HDDs), network information storage devices and/or servers, etc.) or any application in which information encoding and/or decoding is desired.

Generally speaking, when considering a communication system in which video data is communicated from one location, or subsystem, to another, video data encoding may generally be viewed as being performed at a transmitting end of the communication channel 199, and video data decoding may generally be viewed as being performed at a receiving end of the communication channel 199.

Also, while the embodiment of this diagram shows bi-directional communication being capable between the communication devices 110 and 120, it is of course noted that, in some embodiments, the communication device 110 may include only video data encoding capability, and the communication device 120 may include only video data decoding capability, or vice versa (e.g., in a uni-directional communication embodiment such as in accordance with a video broadcast embodiment).

Referring to the communication system 200 of FIG. 2, at a transmitting end of a communication channel 299, information bits 201 (e.g., corresponding particularly to video data in one embodiment) are provided to a transmitter 297 that is operable to perform encoding of these information bits 201 using an encoder and symbol mapper 220 (which may be viewed as being distinct functional blocks 222 and 224, respectively) thereby generating a sequence of discrete-valued modulation symbols 203 that is provided to a transmit driver 230 that uses a DAC (Digital to Analog Converter) 232 to generate a continuous-time transmit signal 204 and a transmit filter 234 to generate a filtered, continuous-time transmit signal 205 that substantially comports with the communication channel 299. At a receiving end of the communication channel 299, continuous-time receive signal 206 is provided to an AFE (Analog Front End) 260 that includes a receive filter 262 (that generates a filtered, continuous-time receive signal 207) and an ADC (Analog to Digital Converter) 264 (that generates discrete-time receive signals 208). A metric generator 270 calculates metrics 209 (e.g., on either a symbol and/or bit basis) that are employed by a decoder 280 to make best estimates of the discrete-valued modulation symbols and information bits encoded therein 210.

Within each of the transmitter 297 and the receiver 298, any desired integration of various components, blocks, functional blocks, circuitries, etc. Therein may be implemented. For example, this diagram shows a processing module 280a as including the encoder and symbol mapper 220 and all associated, corresponding components therein, and a processing module 280 is shown as including the metric generator 270 and the decoder 280 and all associated, corresponding components therein. Such processing modules 280a and 280b may be respective integrated circuits. Of course, other boundaries and groupings may alternatively be performed without departing from the scope and spirit of the invention. For example, all components within the transmitter 297 may be included within a first processing module or integrated circuit, and all components within the receiver 298 may be included within a second processing module or integrated circuit. Alternatively, any other combination of components within each of the transmitter 297 and the receiver 298 may be made in other embodiments.

As with the previous embodiment, such a communication system 200 may be employed for the communication of video data is communicated from one location, or subsystem, to another (e.g., from transmitter 297 to the receiver 298 via the communication channel 299).

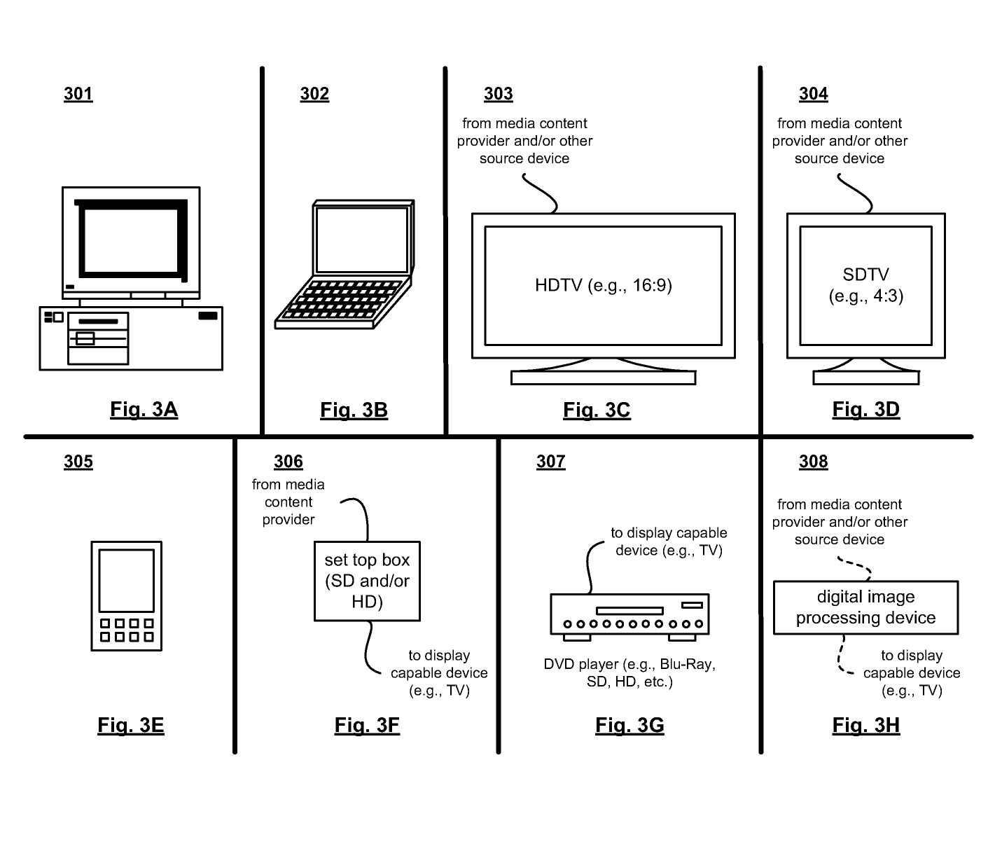

Digital image processing of digital images (including the respective images within a digital video signal) may be performed by any of the various devices depicted below in FIG. 3A-3H to allow a user to view such digital images and/or video. These various devices do not include an exhaustive list of devices in which the image and/or video processing described herein may be effectuated, and it is noted that any generic digital image and/or video processing device may be implemented to perform the processing described herein without departing from the scope and spirit of the invention.

FIG. 3A illustrates an embodiment of a computer 301. The computer 301 can be a desktop computer, or an enterprise storage devices such a server, of a host computer that is attached to a storage array such as a redundant array of independent disks (RAID) array, storage router, edge router, storage switch and/or storage director. A user is able to view still digital images or video (e.g., a sequence of digital images) using the computer 301. Oftentimes, various image viewing programs and/or media player programs are included on a computer 301 to allow a user to view such images (including video).

FIG. 3B illustrates an embodiment of a laptop computer 302. Such a laptop computer 302 may be found and used in any of a wide variety of contexts. In recent years, with the ever-increasing processing capability and functionality found within laptop computers, they are being employed in many instances where previously higher-end and more capable desktop computers would be used. As with the computer 301, the laptop computer 302 may include various image viewing programs and/or media player programs to allow a user to view such images (including video).

FIG. 3C illustrates an embodiment of a high definition (HD) television 303. Many HD televisions 303 include an integrated tuner to allow the receipt, processing, and decoding of media content (e.g., television broadcast signals) thereon. Alternatively, sometimes an HD television 303 receives media content from another source such as a digital video disc (DVD) player, set top box (STB) that receives, processes, and decodes a cable and/or satellite television broadcast signal. Regardless of the particular implementation, the HD television 303 may be implemented to perform image processing as described herein. Generally speaking, an HD television 303 has capability to display HD media content and oftentimes is implemented having a 16:9 widescreen aspect ratio.

FIG. 3D illustrates an embodiment of a standard definition (SD) television 304. Of course, an SD television 304 is somewhat analogous to an HD television 303, with at least one difference being that the SD television 304 does not include capability to display HD media content, and an SD television 304 oftentimes is implemented having a 4:3 full screen aspect ratio. Nonetheless, even an SD television 304 may be implemented to perform image processing as described herein.

FIG. 3E illustrates an embodiment of a handheld media unit 305. A handheld media unit 305 may operate to provide general storage or storage of image/video content information such as joint photographic experts group (JPEG) files, tagged image file format (TIFF), bitmap, motion picture experts group (MPEG) files, Windows Media (WMA/WMV) files, other types of video content such as MPEG4 files, etc. for playback to a user, and/or any other type of information that may be stored in a digital format. Historically, such handheld media units were primarily employed for storage and playback of audio media; however, such a handheld media unit 305 may be employed for storage and playback of virtual any media (e.g., audio media, video media, photographic media, etc.). Moreover, such a handheld media unit 305 may also include other functionality such as integrated communication circuitry for wired and wireless communications. Such a handheld media unit 305 may be implemented to perform image processing as described herein.

FIG. 3F illustrates an embodiment of a set top box (STB) 306. As mentioned above, sometimes a STB 306 may be implemented to receive, process, and decode a cable and/or satellite television broadcast signal to be provided to any appropriate display capable device such as SD television 304 and/or HD television 303. Such an STB 306 may operate independently or cooperatively with such a display capable device to perform image processing as described herein.

FIG. 3G illustrates an embodiment of a digital video disc (DVD) player 307. Such a DVD player may be a Blu-Ray DVD player, an HD capable DVD player, an SD capable DVD player, an up-sampling capable DVD player (e.g., from SD to HD, etc.) without departing from the scope and spirit of the invention. The DVD player may provide a signal to any appropriate display capable device such as SD television 304 and/or HD television 303. The DVD player 305 may be implemented to perform image processing as described herein.

FIG. 3H illustrates an embodiment of a generic digital image processing device 308. Again, as mentioned above, these various devices described above do not include an exhaustive list of devices in which the image processing described herein may be effectuated, and it is noted that any generic digital image processing device 308 may be implemented to perform the image processing described herein without departing from the scope and spirit of the invention.

In the current video coding standard AVC/H.264 (as described in reference [1]), each respective pixel composing a picture (image) is predicted through either inter or intra-prediction.

The intra-prediction processing approach described herein and in accordance with the principles described herein involves creating a prediction of pixels within a current block of pixels using neighboring pixels from that very same picture (image). For comparison, inter prediction (as opposed intra-prediction) involves predicting pixels of the current block using pixels from previously decoded pictures (images) and not those within the very same picture (image) (e.g., motion compensated prediction).

For luma intra-prediction, pixels within respective blocks of a picture (image) can be predicted using blocks of pixels including 4×4 and 8×8 sized prediction blocks as shown in Table 1, or 16×16 sized prediction blocks as shown in Table 2, or generally N×N (where N is an integer) sized prediction blocks. Analogously, chroma blocks may be predicted on 8×8 sized prediction blocks as shown in Table 3 or generally M×M (where M is an integer) prediction blocks.

As shown below within Table 1, both 4×4 and 8×8 luma prediction use one of nine different prediction modes (shown as varying from 0 to 8). Other than DC prediction, each of these respective modes can be considered a directional propagation of the top and/or left pixels to fill the current block and associated with a corresponding prediction vector.

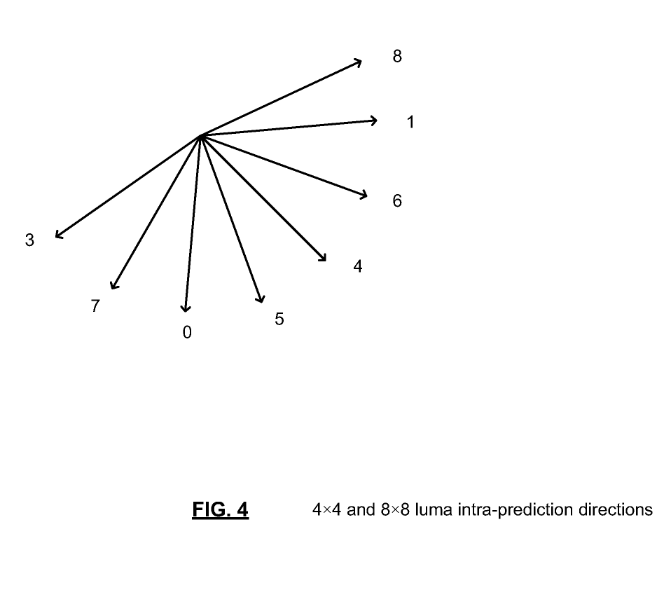

FIG. 4 illustrates an embodiment of a 4×4 and 8×8 luma intra-prediction directions. The directions represented by each respective mode are shown in FIG. 4.

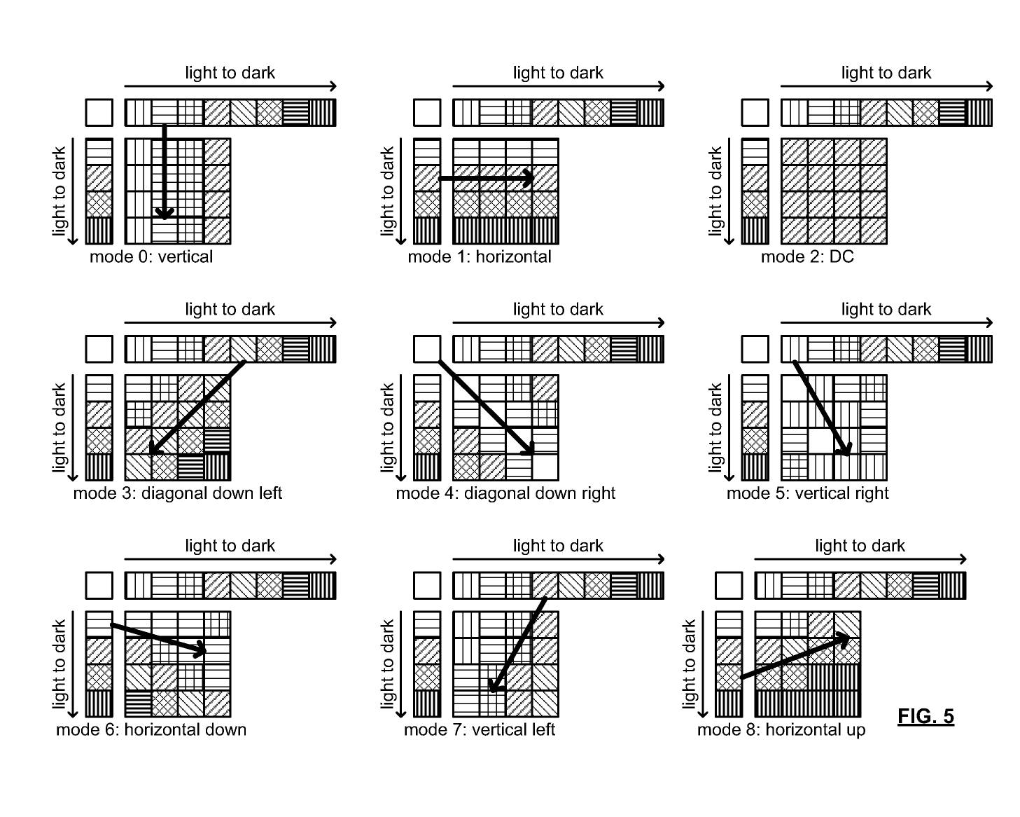

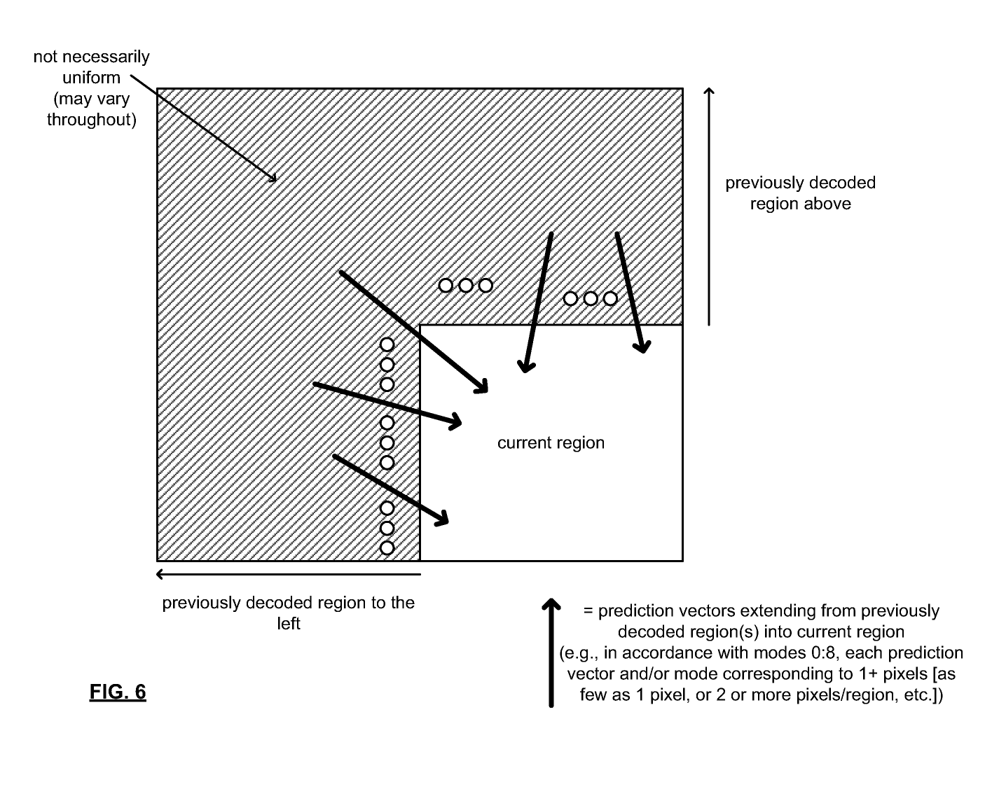

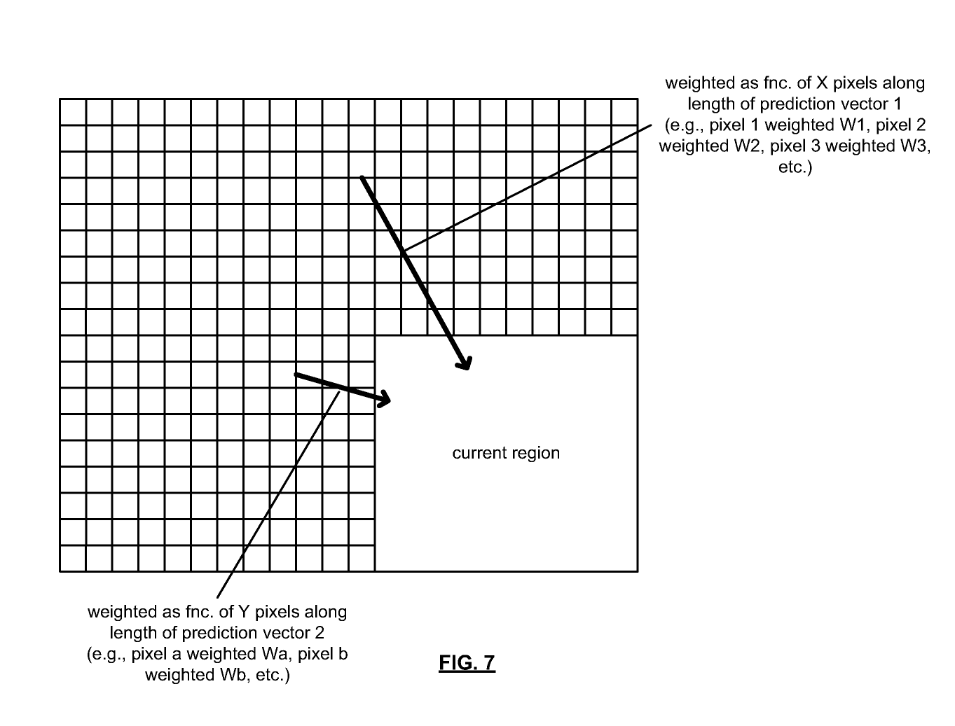

FIG. 5 illustrates an embodiment of a plurality of possible operational modes for 4×4 luma intra-prediction. Some examples of 4×4 spatial prediction with each of the 9 available modes are shown in FIG. 5. As may be seen in the diagram, each respective intra-prediction mode has an associated prediction vector extending from pixels located to the left and/or above the one or more pixels of current interest. As may also be seen in the diagram, each respective operational mode has an associated prediction vector extending in a direction that correlates to the name of that operational mode.

In one embodiment, for each respective block, the encoder (e.g., included within the source or transmitting device from which the video data is being sent) must select an operational mode and transmit these selected operational modes to the decoder (e.g., included within the recipient or receiving device to which the video data is sent for use in being output or displayed). The number of bits needed to transmit this associated information (e.g., overhead corresponding to the selected operational modes) can be significant and can compete with the throughput of the actual video data from the encoder to the decoder. This can be especially deleterious when coding efficiency is a primary concern. That is to say, every non-video data bit that must be transmitted from the encoder to the decoder competes with the video data itself, and can reduce the overall coding efficiency of the communication system operating to communicate the video data from a first location to a second location. Presently, video coding experts are working together on a more advanced standard called HEVC (or MPEG-H) aiming for 50% efficiency improvement relative to AVC/H.264. There are several new intra-prediction methods that have been proposed during this development. Two of those methods have been documented (as described in reference [2]) and implemented in the HEVC software model (as described in reference [3]). While these attempts do have some promising advantages, one being the extension of the number of intra-prediction directions of AVC/H.264 from 9 modes to 33 or more different modes, they nonetheless incur a significant increase in overhead. That is to say, by adding this large number of new operational modes (e.g., increasing from 9 to 33), the number of bits necessary to describe the intra-prediction direction for a given block (or prediction unit (PU)) will also be significantly increased thereby also reducing the overall coding efficiency of the communication system operating to communicate the video data from a first location to a second location.

While on one hand, including more directional modes could in fact help improve prediction, the significant increase in overhead required to transmit all of these additional overhead bits to code these extra intra-prediction modes can directly compete with the overall coding efficiency of the communication system. As such, it can be seen that introducing additional control or overhead bits competes with actual video data to be transmitted from a first location to a second location for output or display.

TABLE 1
Intra 4 × 4 and 8 × 8 luma modes
4 × 4 and 8 × 8 Intra-prediction Modes

0 - Vertical prediction
1 - Horizontal prediction
2 - DC prediction
3 - Diagonal down left prediction
4 - Diagonal down right prediction
5 - Vertical right prediction
6 - Horizontal down prediction
7 - Vertical left prediction
8 - Horizontal up prediction

TABLE 2
Intra 16 × 16 luma modes
Intra 16 × 16 Prediction Modes

0 - Vertical prediction
1 - Horizontal prediction
2 - DC prediction
3 - Plane prediction

TABLE 3
Intra 8 × 8 chroma modes
Intra Chroma Prediction Modes

0 - DC prediction
1 - Horizontal prediction
2 - Vertical prediction
3 - Plane prediction

FIG. 6 illustrates an embodiment of a decoder side intra-prediction derivation (DIPD) with respect to a digital image (e.g., one respective digital image of a video data signal). Herein, decoder side intra-prediction derivation (DIPD) can be employed within respective digital images of video data.

As described above, one approach for performing communication of video data from a first location or device including an encoder to a second location or device is for the encoder to select the intra-prediction mode and communicate this information to the decoder using extra bits that cut into coding efficiency (e.g., compete with the available bandwidth that may alternatively be used to communicate actual video data). At the receiving end of the communication channel, the decoder does relatively little in comparison and simply uses the selected mode (as received from the encoder) to generate its prediction.

However, as a digital picture (image) is decoded on the receiving end, the decoder has a great deal of information within that very same digital picture (image) from previously decoded pixels located to the left and/or above the current block. As may be seen herein, a decoder can use this just decoded information from within a given digital picture (image) to search on its own for the most likely intra-prediction direction without necessitating such direction and control the encoder. For example, FIG. 6 shows how a number of prediction vectors extend into the current region (e.g., a plurality of pixels) from other pixels located to the left and/or above the current region within an image of the video data. Based on these prediction vectors, the values for respective pixels within the current region may be calculated. It is noted that each respective prediction vector may be employed for calculating a respective one pixel. Alternatively, each respective prediction vector may be employed for calculating more than one respective pixel (e.g., a single prediction vector may be employed for prediction vector a plurality of pixels).

A processing module, such as included within a device operative to perform video and/or image processing, can operate by calculating a first plurality of pixels (e.g., current region) using a plurality of prediction vectors extending into the first plurality of pixels (e.g., current region) from a second plurality of pixels located to the left and/or above the first plurality of pixels (e.g., current region) within an image of the video data. As may be seen, just decoded pixels within a same picture (image) may be used to decode other pixels within that very same picture (image). The processing module may then operate by constructing the image of the video data using both the first plurality of pixels (e.g., pixels within the current region that have been most recently decoder) and the second plurality of pixels (e.g., just decoded pixels within that very same picture (image) to the left and/or above).

In many cases, the spatial redundancy that may exist within a coded picture (image) is significant enough to allow a relatively accurate guess at which prediction direction or which prediction vector is most likely going to work well in the next ‘current’ block to be decoded. A decoder can perform this task and reduce or eliminate the need for the encoder to send so many intra-prediction mode bits (e.g., as control or overhead bits).

In all such cases, the encoder can perform the exact same or similar search as the decoder in order to know exactly which direction the decoder will ultimately select. Within such systems, it is noted that both the encoder and decoder should be in synchronization and be on the same page in this respect so that they both generate identical predicted pixels.

FIG. 7 illustrates an embodiment of a selective and different weighting of prediction vectors with respect to a digital image. As may be seen with respect to various prediction vectors, different prediction vectors may extend different lengths back into the just decoded pixels located to the left and/or above of the current region. Moreover, each respective pixel associated with a given prediction vector may be weighted differently as well. For example, those pixels closer to the current region may be weighted more than those pixels further from the current region along a given prediction vector.

With respect to performing communication of video data from a first location or device to a second location or device, there are at least three approaches to be considered in accordance with the various aspects and principles of the invention.

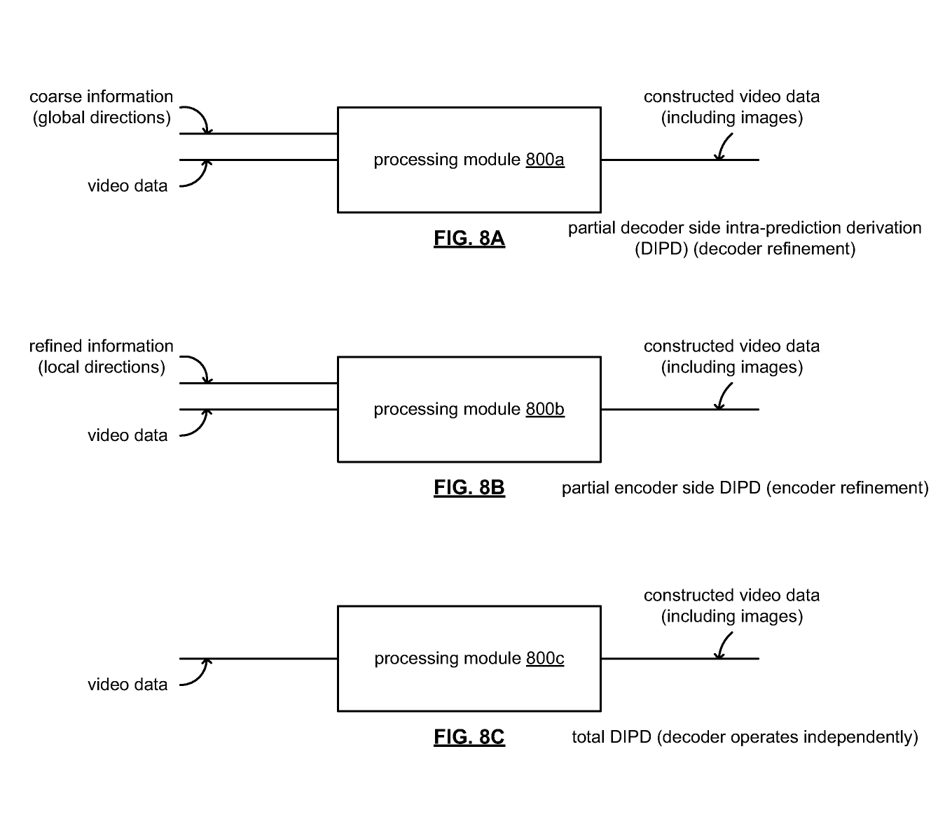

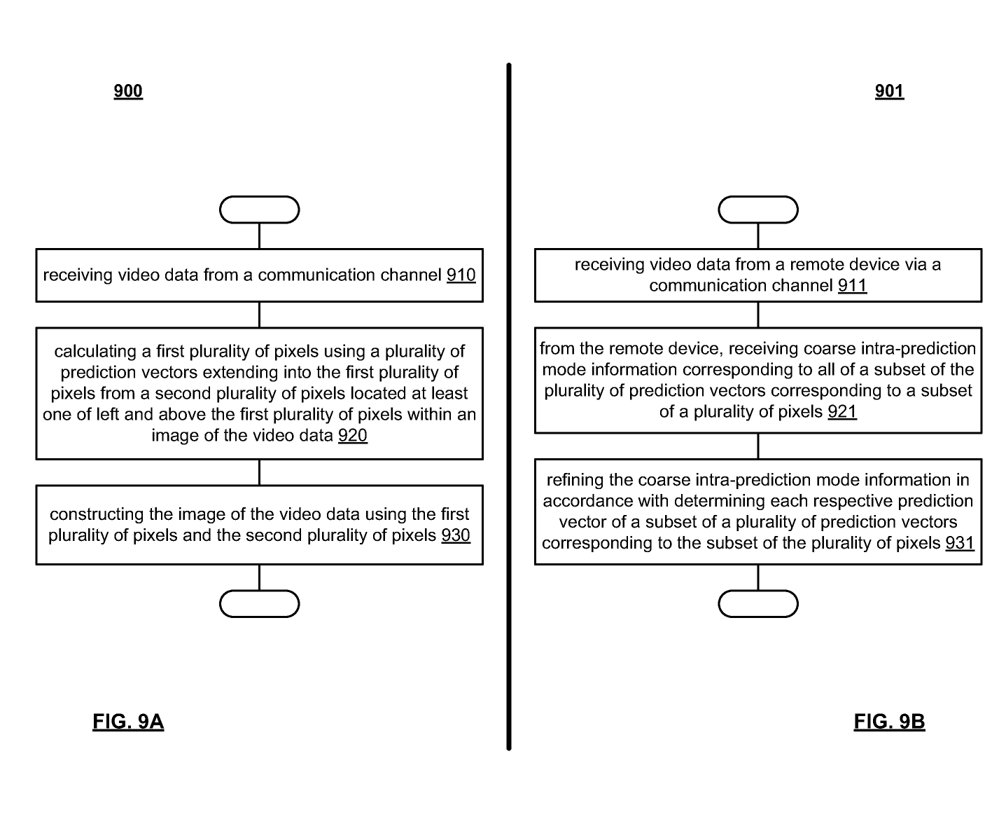

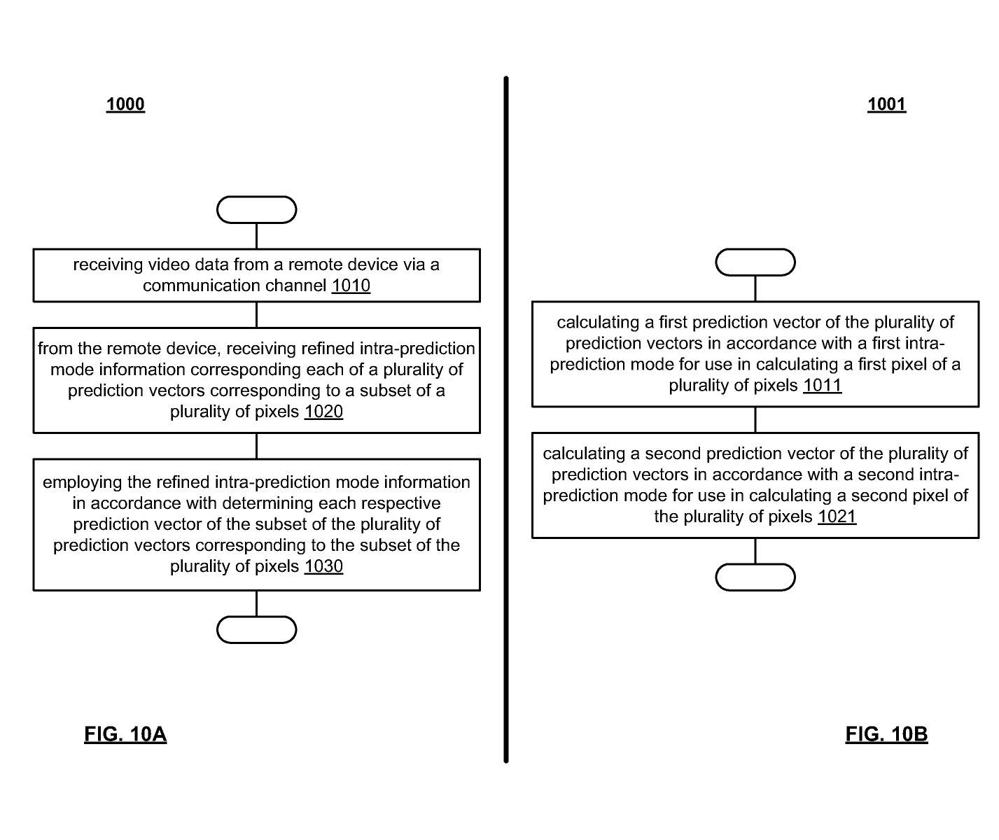

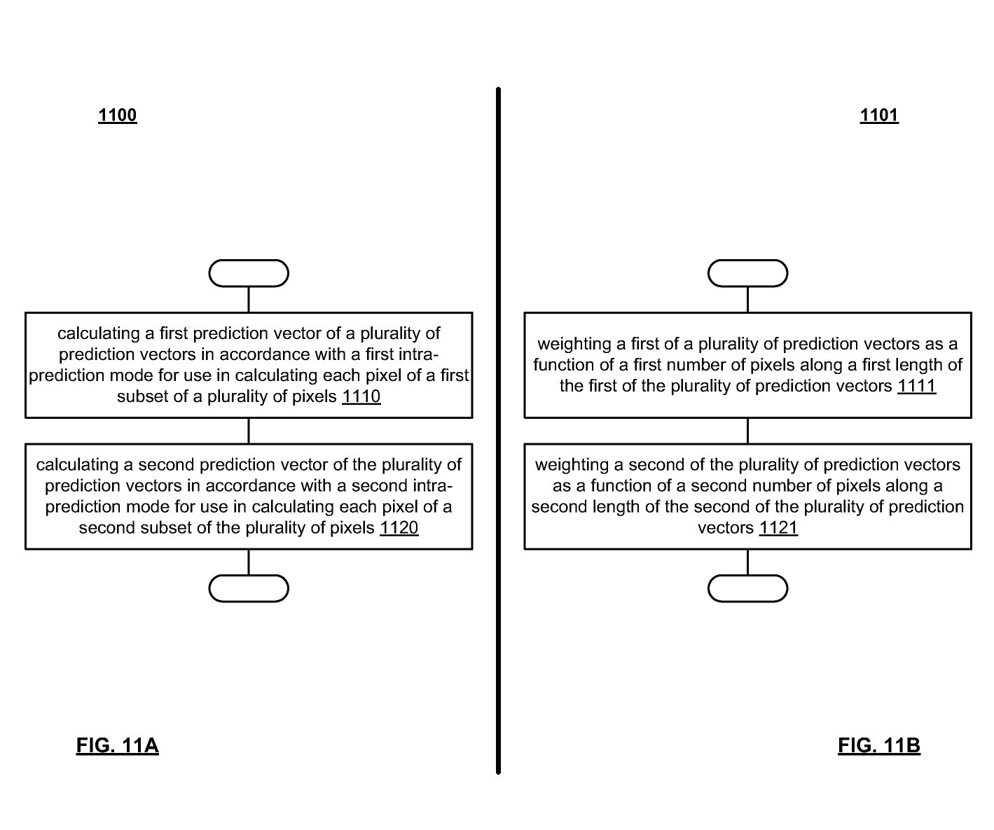

FIG. 8A illustrates an embodiment of partial decoder side intra-prediction derivation (DIPD) operating in accordance with decoder refinement. In accordance with this image or video processing approach, a processing module 800a is operative to receive not only video data (such as from a communication channel) and also coarse information (global directions). In this approach, there are a fixed number of global directions D (e.g., D=9 as 9 directions given in AVC/H.264) or a fixed number of prediction vectors that may be employed to perform decoding of a picture (image). Around every global direction, there could be several local directions. These local directions will not be transmitted from the encoder to the decoder, but coarse information corresponding to the global directions can be transmitted from the encoder to the decoder. Given the best global direction from the encoder, the decoder then is operative to refine this mode by searching for the best local direction using reconstructed prediction units (PUs) around the current PU or current region. In this way, the extra bits that would have alternatively been used to code the local direction are then saved thereby increasing the coding efficiency.

FIG. 8B illustrates an embodiment of partial DIPD operating in accordance with encoder refinement. In accordance with this image or video processing approach, a processing module 800b is operative to receive not only video data (such as from a communication channel) and also refined information (local directions). As may be understood, this approach is similar to the previous embodiment [e.g., partial DIPD operating in accordance with decoder refinement] with at least one exception being that the coarse information (global directions/modes) are determined by the DIPD search on the decoder side, and the encoder uses only a few bits to refine this decision by selecting the best local direction.

FIG. 8C illustrates an embodiment of a total DIPD in which a decoder operates independently on received video data. In accordance with this image or video processing approach, a processing module 800c is operative to receive only video data (such as from a communication channel). No additional associated coarse and/or refined information is transmitted from the encoder to the decoder. In this approach, no directions (e.g., coarse and/or refined) will be transmitted from the encoder to the decoder. The decoder then finds the prediction direction for every PU entirely by itself (e.g., without any additional information provided from the encoder). As may be seen, this approach can significantly reduce the overhead completely to zero bits, but the decoder side mode search approach may then include a slightly more sophisticated approach to prevent bad decisions (e.g., since it does not include any such directional information being coarse and/or refined). As may be seen, the encoder only transmits the video data to the decoder, yet each of the encoder and the decoder when operating independently should arrive at the same resultant picture (image).

Also, because the decoder will be making some or all of the intra-prediction mode decisions, there is no real reason to restrict the decoder to select only a single direction per block. As mentioned above, within a given block or group of pixels, each respective prediction vector may be employed for calculating a respective one pixel. Alternatively, each respective prediction vector may be employed for calculating more than one respective pixel (e.g., a single prediction vector may be employed for prediction vector a plurality of pixels). In accordance with the AVC/H.264 and the proposals for HEVC/MPEG-H, only one mode per block is use because it is too expensive to explicitly transmit modes (e.g., overhead) for each individual pixel.

However, if these modes are instead determined on the decoder side using DIPD in accordance with the various aspects and principles of the invention, each pixel or region could be predicted along independent directions (e.g., such as in accordance with the embodiment depicted in FIG. 3). Certain regions could be predicted vertically, other regions predicted along the diagonal-left, and so on, in accordance with region-dependent prediction (e.g., vertical, horizontal, etc.).

It is also noted that the shapes of such ‘current regions’ and the pixels associated therewith can have any desired shape including having pixels that are non-contiguous with respect to each other. For example, a ‘current region’ may be composed of any desired shape such as a checker board shape, non-contiguous or non-adjacent respective groups of pixels, etc.

FIG. 9A, FIG. 9B, FIG. 10A, FIG. 10B, FIG. 11A, and FIG. 11B illustrate various embodiments of methods for operating video processing devices.

Referring to method 900 of FIG. 9A, the method 900 begins by receiving video data from a communication channel, as shown in a block 910. The method 900 continues by calculating a first plurality of pixels using a plurality of prediction vectors extending into the first plurality of pixels from a second plurality of pixels located at least one of left and above the first plurality of pixels within an image of the video data, as shown in a block 920. The method 900 then operates by constructing the image of the video data using the first plurality of pixels and the second plurality of pixels, as shown in a block 930.

Referring to method 901 of FIG. 9B, the method 901 begins by receiving video data from a remote device via a communication channel, as shown in a block 911. From the remote device, the method 901 then operates by receiving coarse intra-prediction mode information corresponding to all of a subset of the plurality of prediction vectors corresponding to a subset of a plurality of pixels, as shown in a block 921.

The method 901 continues by refining the coarse intra-prediction mode information in accordance with determining each respective prediction vector of a subset of a plurality of prediction vectors corresponding to the subset of the plurality of pixels, as shown in a block 931.

Referring to method 1000 of FIG. 10A, the method 1000 begins by receiving video data from a remote device via a communication channel, as shown in a block 1010. From the remote device, the method 1000 continues by receiving refined intra-prediction mode information corresponding each of a plurality of prediction vectors corresponding to a subset of a plurality of pixels, as shown in a block 1020.

The method 1000 then operates by employing the refined intra-prediction mode information in accordance with determining each respective prediction vector of the subset of the plurality of prediction vectors corresponding to the subset of the plurality of pixels, as shown in a block 1030.

Referring to method 1001 of FIG. 10B, the method 1001 begins by calculating a first prediction vector of the plurality of prediction vectors in accordance with a first intra-prediction mode for use in calculating a first pixel of a plurality of pixels, as shown in a block 1011. The method 1001 then operates by calculating a second prediction vector of the plurality of prediction vectors in accordance with a second intra-prediction mode for use in calculating a second pixel of the plurality of pixels, as shown in a block 1021.

Referring to method 1100 of FIG. 11A, the method 1100 begins by calculating a first prediction vector of a plurality of prediction vectors in accordance with a first intra-prediction mode for use in calculating each pixel of a first subset of a plurality of pixels, as shown in a block 1110. The method 1100 continues by calculating a second prediction vector of the plurality of prediction vectors in accordance with a second intra-prediction mode for use in calculating each pixel of a second subset of the plurality of pixels, as shown in a block 1120.

Referring to method 1101 of FIG. 11B, the method 1101 begins by weighting a first of a plurality of prediction vectors as a function of a first number of pixels along a first length of the first of the plurality of prediction vectors, as shown in a block 1111. The method 1101 then operates by weighting a second of the plurality of prediction vectors as a function of a second number of pixels along a second length of the second of the plurality of prediction vectors, as shown in a block 1121.

It is noted that the various modules and/or circuitries (e.g., for video processing, encoding and/or decoding, etc.) described herein may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The operational instructions may be stored in a memory. The memory may be a single memory device or a plurality of memory devices. Such a memory device may be a read-only memory (ROM), random access memory (RAM), volatile memory, non-volatile memory, static memory, dynamic memory, flash memory, and/or any device that stores digital information. It is also noted that when the processing module implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry. In such an embodiment, a memory stores, and a processing module coupled thereto executes, operational instructions corresponding to at least some of the steps and/or functions illustrated and/or described herein.

It is also noted that any of the connections or couplings between the various modules, circuits, functional blocks, components, devices, etc. within any of the various diagrams or as described herein may be differently implemented in different embodiments. For example, in one embodiment, such connections or couplings may be direct connections or direct couplings there between. In another embodiment, such connections or couplings may be indirect connections or indirect couplings there between (e.g., with one or more intervening components there between). Of course, certain other embodiments may have some combinations of such connections or couplings therein such that some of the connections or couplings are direct, while others are indirect. Different implementations may be employed for effectuating communicative coupling between modules, circuits, functional blocks, components, devices, etc. without departing from the scope and spirit of the invention.

As one of average skill in the art will appreciate, the term “substantially” or “approximately”, as may be used herein, provides an industry-accepted tolerance to its corresponding term. Such an industry-accepted tolerance ranges from less than one percent to twenty percent and corresponds to, but is not limited to, component values, integrated circuit process variations, temperature variations, rise and fall times, and/or thermal noise. As one of average skill in the art will further appreciate, the term “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of average skill in the art will also appreciate, inferred coupling (i.e., where one element is coupled to another element by inference) includes direct and indirect coupling between two elements in the same manner as “operably coupled”. As one of average skill in the art will further appreciate, the term “compares favorably”, as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

Various aspects of the present invention have also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

Various aspects of the present invention have been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, various aspects of the present invention are not limited to such embodiments. It will be obvious to one of average skill in the art that various changes and modifications may be practiced within the spirit and scope of the invention, as limited only by the scope of the appended claims.

### REFERENCES

[1] ITU-T. Recommendation H.264 and ISO/IEC 14496-10 AVC, “Advanced video coding for generic audiovisual services,” 3/2010.
[2] JCT-VC B205, “Test Model under Consideration,” Joint Collaborative Team on Video Coding (JCT-VC) of ITU-T SG16 WP3 and ISO/IEC JTC1/SC29/WG11 2nd Meeting: Geneva, CH, 21-28 Jul., 2010.
[3] Test Model under Consideration software, version 0.7 August, 2010.

What is claimed is:

1. An apparatus, comprising:
an input for receiving video data from a communication channel; and
a processing module for:
calculating a first plurality of pixels using a plurality of prediction vectors extending into the first plurality of pixels from a second plurality of pixels located at least one of left and above the first plurality of pixels within an image of the video data; and
constructing the image of the video data using the first plurality of pixels and the second plurality of pixels.

2. The apparatus of claim 1, wherein:
a first of the plurality of prediction vectors extending via a first number of pixels into the first plurality of pixels from the second plurality of pixels; and
a second of the plurality of prediction vectors extending via a second number of pixels into the first plurality of pixels from the second plurality of pixels.

3. The apparatus of claim 2, wherein:
the first of the plurality of prediction vectors being weighted as a function of the first number of pixels along a first length of the first of the plurality of prediction vectors; and
the second of the plurality of prediction vectors being weighted as a function of the second number of pixels along a second length of the second of the plurality of prediction vectors.

4. The apparatus of claim 1, wherein:
each of the plurality of prediction vectors corresponding to a respective one of a plurality of intra-prediction modes.

5. The apparatus of claim 1, wherein:
at least two of the plurality of prediction vectors corresponding to a common, respective one of a plurality of intra-prediction modes.

6. The apparatus of claim 1, wherein:
the apparatus receiving the video data from at least one additional apparatus via the communication channel;
from the at least one additional apparatus, the apparatus receiving coarse intra-prediction mode information corresponding to all of a subset of the plurality of prediction vectors corresponding to a subset of the first plurality of pixels; and
the processing module refining the coarse intra-prediction mode information in accordance with determining each respective prediction vector of the subset of the plurality of prediction vectors corresponding to the subset of the first plurality of pixels.

7. The apparatus of claim 1, wherein:
the apparatus receiving the video data from at least one additional apparatus via the communication channel; and
from the at least one additional apparatus, the apparatus receiving refined intra-prediction mode information corresponding to each respective prediction vector of a subset of the plurality of prediction vectors corresponding to a subset of the first plurality of pixels.

8. The apparatus of claim 1, wherein:
the processing module calculating a first prediction vector of the plurality of prediction vectors in accordance with a first intra-prediction mode for use in calculating a first pixel of the first plurality of pixels; and
the processing module calculating a second prediction vector of the plurality of prediction vectors in accordance with a second intra-prediction mode for use in calculating a second pixel of the first plurality of pixels.

9. The apparatus of claim 1, wherein:
the processing module calculating a first prediction vector of the plurality of prediction vectors in accordance with a first intra-prediction mode for use in calculating each pixel of a first subset of the first plurality of pixels; and
the processing module calculating a second prediction vector of the plurality of prediction vectors in accordance with a second intra-prediction mode for use in calculating each pixel of a second subset of the first plurality of pixels.

10. The apparatus of claim 1, wherein:
the apparatus being operative within at least one of a satellite communication system, a wireless communication system, a wired communication system, and a fiber-optic communication system.

11. An apparatus, comprising:
an input for:
from at least one additional apparatus, receiving video data via a communication channel; and
from the at least one additional apparatus, receiving intra-prediction mode information corresponding to a subset of a plurality of prediction vectors corresponding to a subset of a first plurality of pixels; and
a processing module for:
employing the intra-prediction mode information in accordance with calculating a plurality of prediction vectors extending into the first plurality of pixels from a second plurality of pixels located at least one of left and above the first plurality of pixels within an image of the video data;
employing the plurality of prediction vectors for calculating the first plurality of pixels; and
constructing the image of the video data using the first plurality of pixels and the second plurality of pixels.

12. The apparatus of claim 11, wherein:
a first of the plurality of prediction vectors extending via a first number of pixels into the first plurality of pixels from the second plurality of pixels; and
a second of the plurality of prediction vectors extending via a second number of pixels into the first plurality of pixels from the second plurality of pixels.

13. The apparatus of claim 12, wherein:
the first of the plurality of prediction vectors being weighted as a function of the first number of pixels along a first length of the first of the plurality of prediction vectors; and
the second of the plurality of prediction vectors being weighted as a function of the second number of pixels along a second length of the second of the plurality of prediction vectors.

14. The apparatus of claim 11, wherein:
the processing module calculating a first prediction vector of the plurality of prediction vectors in accordance with a first intra-prediction mode for use in calculating a first pixel of the first plurality of pixels; and
the processing module calculating a second prediction vector of the plurality of prediction vectors in accordance with a second intra-prediction mode for use in calculating a second pixel of the first plurality of pixels.

15. The apparatus of claim 11, wherein:
the processing module calculating a first prediction vector of the plurality of prediction vectors in accordance with a first intra-prediction mode for use in calculating each pixel of a first subset of the first plurality of pixels; and
the processing module calculating a second prediction vector of the plurality of prediction vectors in accordance with a second intra-prediction mode for use in calculating each pixel of a second subset of the first plurality of pixels.

16. The apparatus of claim 11, wherein:
the apparatus being operative within at least one of a satellite communication system, a wireless communication system, a wired communication system, and a fiber-optic communication system.

17. A method for operating a video processing device, the method comprising:
receiving video data from a communication channel;
calculating a first plurality of pixels using a plurality of prediction vectors extending into the first plurality of pixels from a second plurality of pixels located at least one of left and above the first plurality of pixels within an image of the video data; and
constructing the image of the video data using the first plurality of pixels and the second plurality of pixels.

18. The method of claim 17, wherein:
a first of the plurality of prediction vectors extending via a first number of pixels into the first plurality of pixels from the second plurality of pixels; and
a second of the plurality of prediction vectors extending via a second number of pixels into the first plurality of pixels from the second plurality of pixels.

19. The method of claim 18, further comprising:
weighting the first of the plurality of prediction vectors as a function of the first number of pixels along a first length of the first of the plurality of prediction vectors; and
weighting the second of the plurality of prediction vectors as a function of the second number of pixels along a second length of the second of the plurality of prediction vectors.

20. The method of claim 17, wherein:
each of the plurality of prediction vectors corresponding to a respective one of a plurality of intra-prediction modes.

21. The method of claim 17, wherein:
at least two of the plurality of prediction vectors corresponding to a common, respective one of a plurality of intra-prediction modes.

22. The method of claim 17, further comprising:
receiving the video data from a remote device via the communication channel;
from the remote device, receiving coarse intra-prediction mode information corresponding to all of a subset of the plurality of prediction vectors corresponding to a subset of the first plurality of pixels; and
refining the coarse intra-prediction mode information in accordance with determining each respective prediction vector of the subset of the plurality of prediction vectors corresponding to the subset of the first plurality of pixels.

23. The method of claim 17, further comprising:
receiving the video data from a remote device via the communication channel;
from the remote device, receiving refined intra-prediction mode information corresponding to each respective prediction vector of a subset of the plurality of prediction vectors corresponding to a subset of the first plurality of pixels; and
employing the refined intra-prediction mode information in accordance with determining each respective prediction vector of the subset of the plurality of prediction vectors corresponding to the subset of the first plurality of pixels.

24. The method of claim 17, further comprising:
calculating a first prediction vector of the plurality of prediction vectors in accordance with a first intra-prediction mode for use in calculating a first pixel of the first plurality of pixels; and
calculating a second prediction vector of the plurality of prediction vectors in accordance with a second intra-prediction mode for use in calculating a second pixel of the first plurality of pixels.

25. The method of claim 17, further comprising:
calculating a first prediction vector of the plurality of prediction vectors in accordance with a first intra-prediction mode for use in calculating each pixel of a first subset of the first plurality of pixels; and
calculating a second prediction vector of the plurality of prediction vectors in accordance with a second intra-prediction mode for use in calculating each pixel of a second subset of the first plurality of pixels.

26. The method of claim 17, wherein:
the video processing device being operative within at least one of a satellite communication system, a wireless communication system, a wired communication system, and a fiber-optic communication system.
